(19) United States
(12) Patent Application Publication
(10) Pub. No.: US 2016/0143481 A1
(43) Pub. Date: May 26, 2016

(54) COFFEE GRINDING MACHINE

(71) Applicant: NUOVA SIMONELLI S.P.A., Belforte Del Chienti (MC) (IT)

(72) Inventor: Francesco MERELLI, Pollenza (MC) (IT)

(73) Assignee: NUOVA SIMONELLI S.P.A., Belforte Del Chienti (MC) (IT)

(21) Appl. No.: 14/940,852

(22) Filed: Nov. 13, 2015

(30) Foreign Application Priority Data
Nov. 20, 2014 (IT) MC2014A000103

(51) Int. Cl. A47J 42/44

(52) U.S. Cl. CPC A47J 42/44

(57) ABSTRACT

A coffee grinding machine has a dispensing duct connected to a grinder unit to dispense coffee inside a filter supported by a filter-holder. The filter-holder is disposed above a support platform connected to a load cell that weighs the quantity of ground coffee contained in the filter and sends an indicative weight value of the ground coffee contained in the filter to a control unit in such manner to stop the grinder unit when the weight of the ground coffee contained in the filter-is equal to one dose. The load cell is inside a support frame that contains the grinder unit and an electric motor used to actuate the grinder unit.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present patent application for industrial invention relates to an improved coffee grinding machine.

2. Description of Related Art Including Information Disclosed Under 37 CFR 1.97 and 37 CFR 1.98

As it is known, a professional coffee machine uses a filter-holder with a filter that must be filled with one or two doses of ground coffee. Two factors are necessary in order to maintain the organoleptic characteristics of the coffee dispensed by the machine:
coffee must be ground from beans immediately before being dispensed; and
the quantity of ground coffee in the filter-holder must respect a predetermined weight according to the dose or doses.

In fact, coffee that was ground long ago will lose its aroma, and doses with an insufficient or exaggerated amount of ground coffee will generate a low-balance drink

In order to solve these drawbacks, at least partially, coffee grinding machine are known, which comprise a grinder unit actuated by an electrical motor to grind coffee beans supplied from a container or hopper in order to dispense ground coffee inside the filter.

Generally speaking, these coffee machines comprise a button that can be manually pushed by the operator to actuate the electrical motor and the grinder unit and to dispense ground coffee.

However, said coffee grinding machines are impaired by some drawbacks.

In fact the quantity of ground coffee dispensed into the filter is empirically adjusted by the operator, who stops the dispensing of ground coffee according to his or her experience when he or she believes that the correct dose of ground coffee has been dispensed. Evidently, such an empirical adjustment is easily affected by mistakes and is often too approximate to guarantee the correct dispensing of an exact dose of coffee.

Automatic coffee grinding machines are known, wherein a predefined actuation time of the grinder unit motor, and consequently a predefined dispensing time of the ground coffee, is stored. Evidently, although such a type of coffee grinding machines releases the operator's from responsibility in terms of the correct dispensing of ground coffee, it is not very efficient or accurate due a plurality of incidental factors that affect the quantity of coffee dispensed during the actuation time of the grinder unit motor. The incidental factors may be the wear of the grinders, the friction between grinders, the cleanness of the grinder unit, and the hardness and dimensions of the coffee beans.

WO2012/138327 discloses a coffee grinding apparatus comprising a support platform and a load cell disposed outside the base structure, under the dispensing duct. The support platform is disposed above the load cell and is permanently fixed to a base portion of the load cell. The structure of the coffee grinding apparatus is impaired by the fact that the load cell must have a special configuration in order to be disposed in the support platform. Evidently, also the support platform must have a special annular configuration in order to receive the load cell. Moreover, the load cell is outside the frame of the apparatus and is subject to the action of foreign agents, such as the coffee powder that comes out of the filter and falls on the load cell. In addition to getting the load cell dirty, foreign agents can cause malfunctioning and inaccurate weighing operations of the load cell.

The purpose of the present invention is to remedy the drawbacks of the prior art by disclosing an automatic coffee grinding machine suitable for guaranteeing the dispensing of a correct dose of ground coffee.

Another purpose of the present invention is to provide such a coffee grinding machine that is precise and reliable.

### BRIEF SUMMARY OF THE INVENTION

These purposes are achieved according to the invention, with the characteristics claimed in the independent claim 1.

Advantageous embodiments of the invention will appear from the dependent claims.

The coffee grinding machine of the invention comprises:
a grinder unit intended to grind coffee beans;
a container, or hopper, used to feed coffee beans to the grinder unit;
an electric motor connected to the grinder unit in order to actuate or stop said grinder unit; and
a dispensing duct connected to the grinder unit to dispense coffee into a filter supported by a filter-holder;
a support platform disposed under said dispensing duct and intended to support the filter-holder in such manner to dispense the ground coffee into the filter;
a load cell connected to the support platform to weigh the quantity of ground coffee dispensed by the dispensing duct and contained in the filter of the filter-holder;
a control unit electrically connected to the load cell to receive an indicative value of the weight of the ground coffee contained in the filter;
a frame that contains the grinder unit, the electric motor and the control unit.

Said control unit comprises:
a memory wherein a predefined weight value of ground coffee corresponding to one dose is stored; and
comparison means that compare the weight of the ground coffee contained in the filter with the predefined value stored in the memory and send a control signal to the electric motor when the weight of the ground coffee contained in the filter reaches the predefined value stored in the memory, in such manner to stop the electric motor and consequently the grinder unit and the dispensing of ground coffee from the dispensing duct.

The load cell is disposed inside said frame. In this way the load cell is protected against external agents and is not affected by the ground coffee powder that can be poured from the filter or the dispensing duct.

The advantages of the coffee grinding machine of the invention are evident, wherein the load cell sends the weight of the ground coffee dispensed in the filter to the control unit so that the comparison means of the control unit can stop the electric motor and consequently, the grinder unit when the weight of the ground coffee dispensed inside the filter reaches the predefined value stored in the memory of the control unit.

In this way, the coffee grinding machine guarantees the correct filling of the filter, accurately measuring the weight of the ground coffee contained in the filter.

The fact that the load cell is protected inside the frame allows for using a load cell with any structure and a compact simple support platform, while guaranteeing the reliability and accuracy of the load cell.

### BRIEF DESCRIPTION OF THE SEVERAL VIEWS OF THE DRAWINGS

Further characteristics of the invention will appear clear from the detailed description below, which refers to merely illustrative, not limiting, embodiments, illustrated in the attached drawings, wherein:

FIG. 1 is a diagrammatic view of the parts of a coffee grinding machine according to the invention.

### DETAILED DESCRIPTION OF THE INVENTION

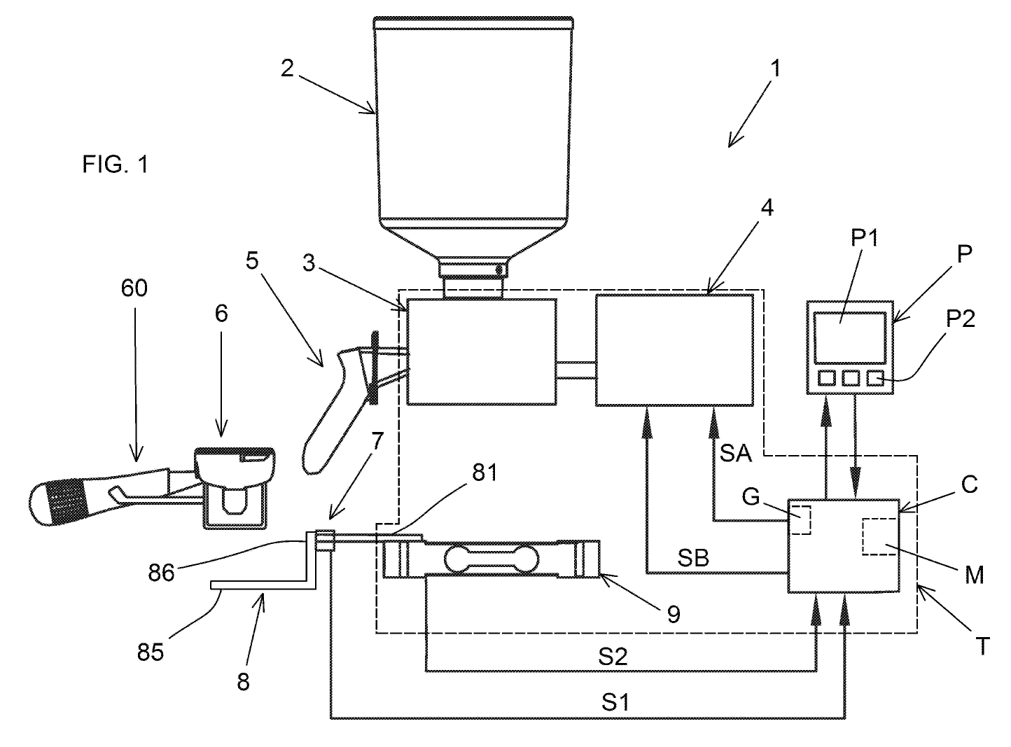

With reference to FIG. 1, a coffee grinding machine according to the invention is disclosed, being comprehensively indicated with reference number (1).

The coffee grinding machine (1) comprises a container or hopper (2) used to feed coffee beans to a grinder unit (3) intended to grind the coffee beans. An electric motor (4) is connected to the grinder unit (3) in order to actuate or to stop said grinder unit (3). A dispensing duct (5) is connected to the grinder unit (3) to dispense ground coffee into a filter (6) supported by a filter-holder (60).

During the actuation of the electric motor (4) the coffee beans are ground by the grinder unit (3) and the ground coffee is dispensed by the dispensing duct (5). When the electric motor (4) is stopped, the dispensing of ground coffee from the dispensing duct (5) is stopped.

The coffee grinding machine (1) comprises a frame (T) that supports and contains the grinder unit (3) and the electric motor (4).

A support platform (8) that is shaped as a plate and disposed along a horizontal plane is positioned under the dispensing duct (5). The support platform (8) is intended to support the filter-holder (60) in such manner to dispense the ground coffee into the filter (6).

The support platform (8) is associated with a load cell (9).

The load cell (9) is suitable for weighing the quantity of ground coffee dispensed by the dispensing duct (5) and contained in the filter (6) of the filter-holder (60).

The load cell (9) is disposed inside the frame (T). In such a case, the support platform (8) is disposed outside the frame (T) and is connected to the load cell (9) by means of a connection bracket (81).

In particular, the support platform (8) has an L-shaped cross-section and comprises a base (85) and a side wall (86) connected to the connection bracket (81). The connection bracket (81) is shaped as a plate and extends from an upper edge of the side wall (86) of the support platform (8) in parallel position to the base (85) of the support platform (8). In view of the above, the weight of the ground coffee contained in the filter (6), which rests on the support platform (8), is transmitted to the load cell (9) through the connection bracket (81).

Although for illustrative purposes the figure depicts an L-shaped support platform (8) and a connection bracket (81) shaped as a plate or shelf, the support platform (8) and the connection bracket (81) can have a different shape.

The coffee grinding machine (1) comprises a control unit (C) electrically connected to the load cell (9) to receive an indicative value of the weight of the ground coffee contained in the filter (6).

The control unit (C) is disposed inside the frame (T) and comprises a memory (M) wherein a predetermined weight value of ground coffee corresponding to one dose or two doses or more doses is stored.

The load cell (9) can be set according to the weight of the filter (6) and filter-holder (60) assembly in such manner to exactly detect the weight of the ground coffee contained in the filter (6). Alternatively, the load cell (9) is not set and directly detects the weight of the filter (6) and filter-holder (60) assembly plus the weight of the ground coffee contained in the filter (6). In such a case, the weight of the filter (6) and filter-holder (60) assembly is stored in the memory (M) of the control unit (C), and s to be subtracted from the weight detected by the load cell (9) in order to obtain the weight of the ground coffee contained in the filter (6).

Considering that a small quantity of ground coffee keeps on being dispensed by the dispensing duct (5) when the grinder unit (3) is stopped, the load cell (9) can be set at a weight that is slightly lower than one coffee dose, taking into account the quantity of ground coffee dispensed by the dispensing duct (5) inside the filter (6) after stopping the grinder unit (3).

Moreover, the control unit (C) comprises comparison means (G) that compare the coffee weight detected by the load cell (9), which corresponds to the coffee contained in the filter (6), with the predefined value stored in the memory (M) and send a stop signal (SA) to the electric motor (4) when the weight of the ground coffee contained in the filter (6) reaches the predefined value stored in the memory (M). The stop signal (SA) stops the electric motor (4) and, consequently, the grinder unit (3) and the dispensing of ground coffee from the dispensing duct (5).

The coffee grinding machine (1) optionally comprises a presence sensor (7) disposed in proximity to the support platform (8) to detect a correct position of the filter-holder (60) on the support platform (8). The presence sensor (7) is electrically connected to the control unit (C).

The presence sensor (7) is advantageously a proximity switch that sends an ON-OFF signal to the control unit (C).

Alternatively or additionally to the presence sensor (7), the coffee grinding machine (1) comprises a manual actuation button connected to a switch to start the grinder unit (3).

The coffee grinding machine (1) also comprises a control panel (P) electrically connected to the control unit (C). The control panel (P) comprises a display (P1) and a push-button panel (P2). The display (P1) is used to display the weight of the ground coffee detected by the load cell (9). The push-button panel (P2) is used to change the predefined weight value of the coffee ground stored in the memory (M) of the control unit (C).

Following is a description of the operation of the coffee grinding machine (1).

When the filter-holder (60) is correctly disposed on the support platform (8), the presence sensor (7) sends a control signal (S1) to the control unit (C) and the control unit (C) sends a start signal (SB) to the electric motor (4) to actuate the electric motor (4) and the grinder unit (3).

The grinder unit (3) starts grinding the coffee beans fed from the container (2) and the ground coffee is dispensed inside the filter (6) through the dispensing duct (5).

While the ground coffee is dispensed inside the filter (6), the load cell (9) sends a signal (S2) indicative of the weight of the ground coffee contained in the filter (6) to the control unit (C).

The comparison means (G) compare the signal (S2) received from the load cell, which is indicative of the weight of the ground coffee contained in the filter (6), with the predefined value stored in the memory (M) and send a stop signal (SA) to the electric motor (4) when the weight of the ground coffee contained in the filter (6) reaches the predefined value stored in the memory (M) in such manner to stop the electric motor (4) and consequently the grinder unit (3) and the dispensing of ground coffee from the dispensing duct (5).

1. A coffee grinding machine comprising:
a grinder unit intended to grind coffee beans,
a container or hopper to feed the coffee beans to the grinder unit,
an electric motor connected to the grinder unit in order to actuate or stop said grinder unit;
a dispensing duct (5) connected to the grinder unit (3) to dispense coffee into a filter supported by a filter-holder;
a support platform disposed under said dispensing duct and intended to support the filter-holder in such manner to dispense the ground coffee into the filter;
a load cell connected to the support platform to weigh the quantity of ground coffee dispensed from the dispensing duct and contained into the filter of the filter-holder;
a control unit electrically connected to the load cell to receive an indicative value of the weight of the ground coffee contained in the filter;
a frame that contains the grinder unit, the electric motor and the control unit;
wherein said control unit comprises:
a memory wherein a predefined weight value of ground coffee that corresponds to one dose is stored; and
comparison means that compare the weight of the ground coffee contained in the filter with the predefined value stored in the memory and send a stop signal to the electric motor when the weight of the ground coffee contained in the filter reaches the predefined value stored in the memory in such manner to stop the electric motor and consequently the grinder unit and the dispensing of ground coffee from the dispensing duct,
wherein said load cell (9) is disposed inside said frame (T).

2. The coffee grinding machine of claim 1, wherein said support platform is disposed outside the frame and connected to the load cell by means of a connection bracket (81).

3. The coffee grinding machine of claim 2, wherein said support platform has an L-shaped cross-section and comprises a base and a side wall connected to said connection bracket and said connection bracket is shaped as a plate and extends from an upper edge of the side wall of the support platform in parallel position to the base of the support platform.

4. The coffee grinding machine of claim 1, also comprising a presence sensor disposed in proximity to the support platform and electrically connected to the control unit, said presence sensor being intended to detect the correct position of the filter-holder on the support platform.

5. The coffee grinding machine of claim 4, wherein said presence sensor is a proximity switch.

6. The coffee grinding machine of claim 1, also comprising a control panel electrically connected to the control unit, said control panel comprising a display and a push-button panel, respectively used to display the weight of the ground coffee detected by the load cell and to modify the predefined weight value of ground coffee stored in the memory of the control unit.

7. The coffee grinding machine of claim 1, wherein the load cell is set in such manner to detect a quantity of ground coffee that is slightly lower than one dose, in consideration of the quantity of ground coffee dispensed from the dispensing duct into the filter after stopping the grinder unit.
